(19) United States
(12) Patent Application Publication
(10) Pub. No.: US 2014/0123277 A1
(43) Pub. Date: May 1, 2014

(54) MOBILE TERMINAL APPARATUS, NON-TRANSITORY COMPUTER READABLE MEDIUMS, SIGNAL PROCESSING METHOD, DOCUMENT STORAGE SERVER, AND DOCUMENT MANAGEMENT SYSTEM

(71) Applicant: FUJI XEROX CO., LTD., Tokyo (JP)

(72) Inventor: Kenji KAWASE, Kanagawa (JP)

(73) Assignee: FUJI XEROX CO., LTD., Tokyo (JP)

(21) Appl. No.: 13/873,641

(22) Filed: Apr. 30, 2013

(30) Foreign Application Priority Data
Oct. 30, 2012 (JP) 2012-238966

(51) Int. Cl. H04L 29/06

(52) U.S. Cl. CPC H04L 63/10
USPC 726/21

(57) ABSTRACT

A mobile terminal apparatus includes a detection unit, a transmission unit, an acquisition unit, and a permission unit. The detection unit detects current position information at a predetermined timing. The transmission unit transmits the current position information, user information that specifies a user, and file specification information that specifies a file that is to be acquired. The acquisition unit acquires a limited-access file, which includes the file and access permission area information that defines an area from which the mobile terminal apparatus is allowed to access the file in accordance with the current position information, in a case where the user is a registered user with a right to download the file. The permission unit gives permission to access the file in a case where accessing of the file is commanded and a position specified by the current position information is included in the area.

### CROSS-REFERENCE TO RELATED APPLICATIONS

This application is based on and claims priority under 35 USC 119 from Japanese Patent Application No. 2012-238966 filed Oct. 30, 2012.

### BACKGROUND

### Technical Field

The present invention relates to a mobile terminal apparatus, non-transitory computer readable mediums, a signal processing method, a document storage server, and a document management system.

### SUMMARY

According to an aspect of the invention, there is provided a mobile terminal apparatus including a detection unit, a transmission unit, an acquisition unit, and a permission unit. The detection unit detects current position information on a current position at a predetermined timing. The transmission unit transmits the current position information, user information that specifies a user of the mobile terminal apparatus, and file specification information that specifies a file that is to be acquired. The acquisition unit acquires a limited-access file from a document storage server that generates the limited-access file, which includes the file and access permission area information that defines an access permission area from which the mobile terminal apparatus is allowed to access the file in accordance with the current position information, in a case where the user specified by the user information is a registered user with a right to download the file specified by the file specification information. The permission unit gives permission to access the file in a case where accessing of the file is commanded and a position specified by the current position information detected by the detection unit is included in the access permission area.

### BRIEF DESCRIPTION OF THE DRAWINGS

Exemplary embodiments of the present invention will be described in detail based on the following figures, wherein:

FIG. 1 illustrates a schematic diagram of the structure of a document storage system;

FIG. 2 illustrates a functional block diagram of a functional structure of a mobile terminal apparatus;

FIG. 3 illustrates a block diagram of a substantial structure of an electrical system of the mobile terminal apparatus;

FIG. 4 illustrates a functional block diagram of a functional structure of a document storage server;

FIG. 5 illustrates a block diagram of a substantial structure of an electrical system of the document storage server;

FIG. 6 illustrates a flowchart of file access processing executed by a computer of a mobile terminal apparatus according to a first exemplary embodiment;

FIG. 7 is a diagram used to describe the structure of a limited-access file;

FIG. 8 is a diagram used to describe a case where the mobile terminal apparatus moves from one place to another;

FIG. 9 is a diagram used to describe a case where the mobile terminal apparatus moves from inside to outside an access permission area;

FIG. 10 illustrates a flowchart of limited-access file generation processing executed by a computer of a document storage server according to the first exemplary embodiment;

FIG. 11 illustrates a flowchart of access permission area replacement processing executed by the computer of the mobile terminal apparatus according to a second exemplary embodiment;

FIG. 12 illustrates details of the flowchart of the access permission area replacement processing executed by the computer of the mobile terminal apparatus according to the second exemplary embodiment; and

FIG. 13 is a diagram used to describe accessing of a file in the case where the mobile terminal apparatus is outside the access permission area.

### DETAILED DESCRIPTION

In the following, exemplary embodiments will be described in detail with reference to the drawings. Note that elements that have the same operation or function are denoted by the same reference numeral throughout in the drawings. The redundant description thereof may be omitted.

### First Exemplary Embodiment

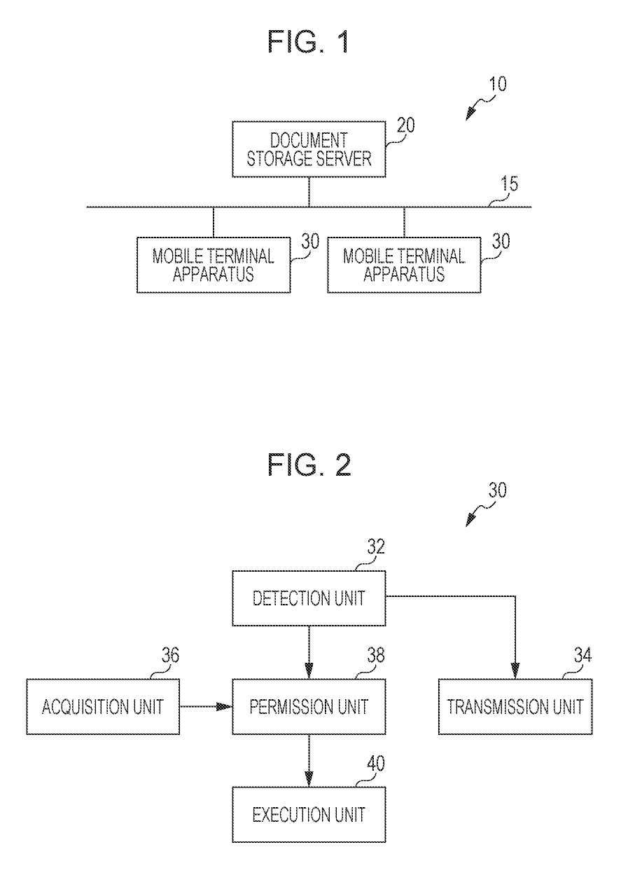

FIG. 1 illustrates a schematic structure of a document management system 10 according to a first exemplary embodiment. As illustrated in FIG. 1, the document management system 10 has a structure in which a document storage server 20 and one or more mobile terminal apparatuses 30 are connected one another through a network 15. The mobile terminal apparatuses 30 are electronic apparatuses carried by users, such as notebook personal computers, mobile phones such as smartphones, tablet computers, and the like.

Here, the structure of the document management system 10 is not limited thereto. For example, plural document storage servers 20 may be connected to the network 15, and the network 15 may be a wired or wireless network.

In the document management system 10, a user specifies a file saved in the document storage server 20 by using a mobile terminal apparatus 30, and obtains (downloads) data of the file from the document storage server 20 into the mobile terminal apparatus 30 through the network 15. Then, in the case where the user commands to start the file downloaded in the mobile terminal apparatus 30, an application program corresponding to the file that the user has commanded to start is executed. The application program is stored in advance in the mobile terminal apparatus 30. The application program reads (accesses) the data of the file that the user has commanded to start, converts the data into text, images, sound, videos, or the like, and shows the converted data to the user.

FIG. 2 is a functional block diagram illustrating a functional structure of the mobile terminal apparatus 30 according to the first exemplary embodiment. As illustrated in FIG. 2, the mobile terminal apparatus 30 according to the first exemplary embodiment includes a detection unit 32, a transmission unit 34, an acquisition unit 36, a permission unit 38, and an execution unit 40.

The detection unit 32 detects, at a predetermined timing, the longitude and latitude (position information) of the current position at which the mobile terminal apparatus 30 is being used, by using a positioning system such as the Global Positioning System (GPS) or the like.

The transmission unit 34 transmits the position information detected by the detection unit 32, user information that identifies uniquely the user of the mobile terminal apparatus 30, such as a user ID, a password, and the like, and file specification information that specifies a file that is to be acquired, to the document storage server 20 through the network 15.

The acquisition unit 36 acquires a limited-access file generated by the document storage server 20, in accordance with the position information, the user information, and the file specification information transmitted by the transmission unit 34. Here, the limited-access file is a file which includes a file that is to be acquired and specified by the file specification information and access permission area information that defines an area from which the mobile terminal apparatus 30 may access the file (hereinafter referred to as an access permission area) in accordance with the position information.

Every time the position information is detected by the detection unit 32 at a predetermined timing, the permission unit 38 determines whether or not the position specified by the position information is within an access permission area defined by the access permission area information included in the limited-access file acquired by the acquisition unit 36. If the position specified by the position information is determined to be within the access permission area, the permission unit 38 permits the file included in the limited-access file to be accessed.

The execution unit 40 executes an application program corresponding to the file that the permission unit 38 permits to be accessed.

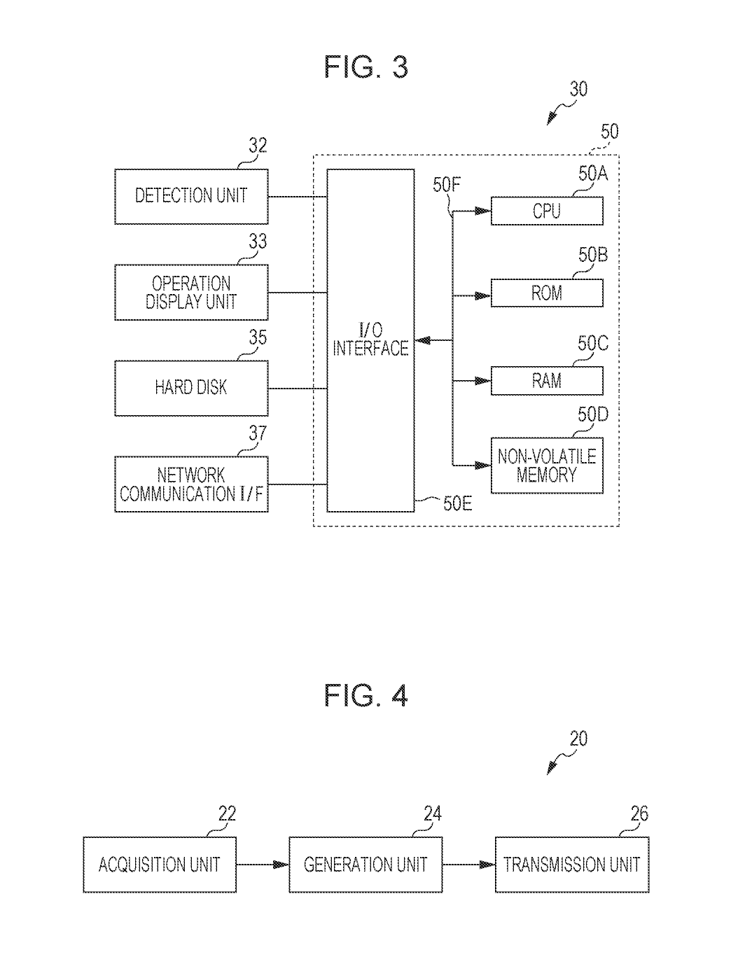

FIG. 3 illustrates a block diagram of a substantial structure of an electrical system of the mobile terminal apparatus 30 according to the first exemplary embodiment. As illustrated in FIG. 3, the mobile terminal apparatus 30 includes a computer 50.

The computer 50 has a structure in which a central processing unit (CPU) 50A, a read-only memory (ROM) 50B, a random-access memory (RAM) 50C, a non-volatile memory 50D, and an input-output (I/O) interface 50E are connected one another via a bus 50F.

Various function units such as the detection unit 32, an operation display unit 33, a hard disk 35, and a network communication interface (I/F) 37 are connected to the I/O interface 50E.

The operation display unit 33 includes, for example, a touch-panel display on which display buttons that accept an operation instruction and various pieces of information are displayed by using a software program, hardware keys such as a power button, and a microphone from which an operation instruction by speech is obtained.

Various application programs and the like are stored on the hard disk 35. For example, the various application programs are used to access the limited-access file acquired by the acquisition unit 36 and a file included in the limited-access file and to display the content of the file on the operation display unit 33. Note that a solid state drive (SSD) may be used as the hard disk 35.

The network communication I/F 37 is connected to the network 15, and is an interface that performs communication to and from the document storage server 20.

Note that, as an example in the first exemplary embodiment, a control program used to perform file access processing, which will be described below, is stored in advance on the hard disk 35, and the CPU 50A reads and executes the control program. Moreover, the control program may be stored in a storage medium such as a CD-ROM and may be read and executed by a CD-ROM drive or the like. Alternatively, the control program may be received through a wired or wireless communication unit and executed.

FIG. 4 is a functional block diagram of a functional structure of the document storage server 20 according to the first exemplary embodiment. As illustrated in FIG. 4, the document storage server 20 according to the first exemplary embodiment includes an acquisition unit 22, a generation unit 24, and a transmission unit 26.

The acquisition unit 22 acquires the position information, the user information, and the file specification information transmitted by the transmission unit 34 of the mobile terminal apparatus 30.

The generation unit 24 generates the limited-access file in the case where the user specified by the user information is authenticated as a registered user with the right to download a file specified by the file specification information. The right to download a file has been previously given to a corresponding registered user or users.

The transmission unit 26 transmits the limited-access file generated by the generation unit 24 to the mobile terminal apparatus 30 that has transmitted the position information, the user information, and the file specification information acquired by the acquisition unit 22.

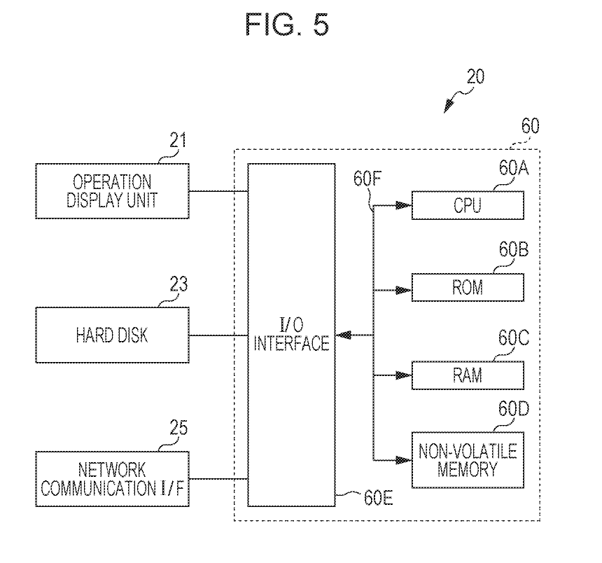

FIG. 5 illustrates a block diagram of a substantial structure of an electrical system of the document storage server 20 according to the first exemplary embodiment. As illustrated in FIG. 5, the document storage server 20 includes a computer 60.

The computer 60 has a structure in which a CPU 60A, a ROM 60B, a RAM 60C, a non-volatile memory 60D, and an I/O interface 60E are connected one another via a bus 60F.

Various function units such as an operation display unit 21, a hard disk 23, and a network communication I/F 25 are connected to the I/O interface 60E.

The operation display unit 21 includes, for example, a liquid crystal display, hardware keys such as a keyboard, a mouse, and the like.

For example, files that may be specified and downloaded by the user of the mobile terminal apparatus 30, registered-user information such as user IDs and passwords of registered users with the right to download the files, and the like are stored on the hard disk 23. Note that an SSD may be used as the hard disk 23.

The network communication I/F 25 is connected to the network 15, and is an interface that performs data communication to and from the mobile terminal apparatus 30.

Note that, as an example in the first exemplary embodiment, a control program used to perform processing for a limited-access file, which will be described below, is stored in advance on the hard disk 23, and the CPU 60A reads and executes the stored control program. Moreover, the control program may be stored in a storage medium such as a CD-ROM and may be read and executed by a CD-ROM drive or the like. Alternatively, the control program may be received through a wired or wireless communication unit and executed.

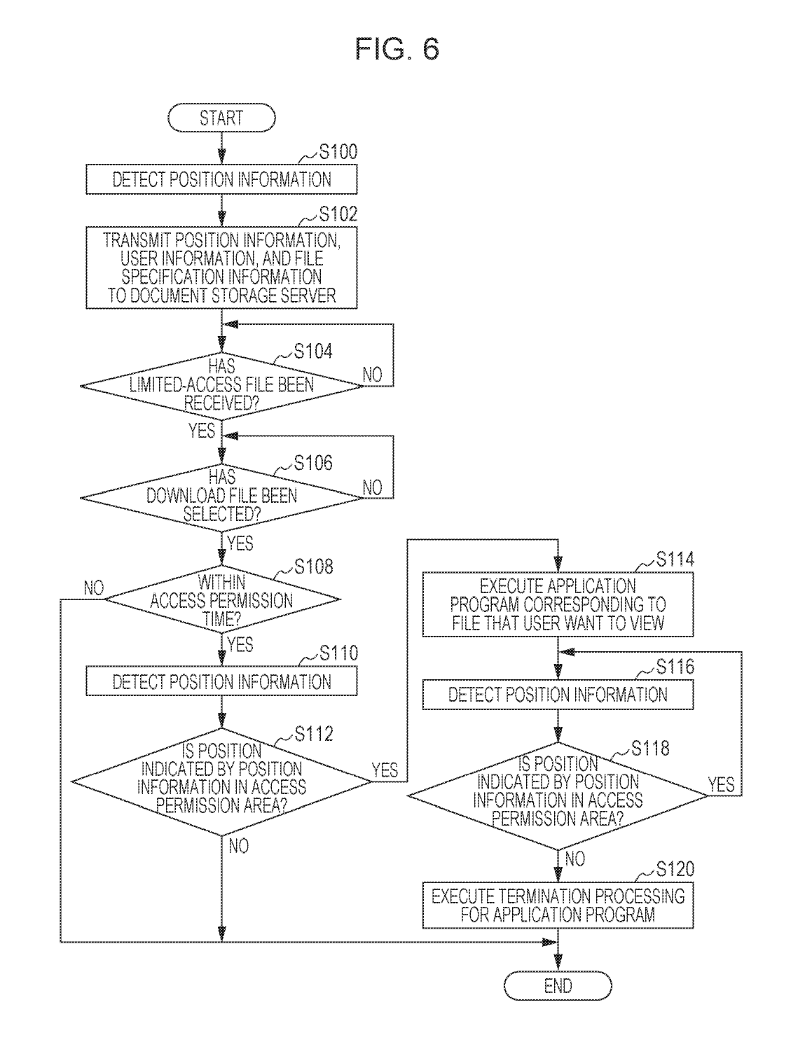

Next, the file access processing executed by the computer 50 of the mobile terminal apparatus 30 will be described with reference to a flowchart illustrated in FIG. 6.

Note that the processing illustrated in FIG. 6 is executed by the CPU 50A, for example, in the case where the user of the mobile terminal apparatus 30 acquires information on the list of files stored on the hard disk 23 of the document storage server 20, starts a file viewer that displays the list of files onto a display of the operation display unit 33, and selects a file that the user wants to download (a download request file) onto the hard disk 35 of the mobile terminal apparatus 30 from among the list of files.

In step S100, the detection unit 32 detects the current position information about the mobile terminal apparatus 30.

In step S102, the user information on the user of the mobile terminal apparatus 30 is read from, for example, a predetermined region of the non-volatile memory 50D. Note that the user information is stored in advance in the predetermined region of the non-volatile memory 50D.

Moreover, the file specification information is acquired. That is, the file name and directory of a selected download request file are acquired, the directory indicating where on the hard disk 23 of the document storage server 20 the selected download request file is stored. Note that plural download request files may be selected.

Then, the current position information detected in step S100, the file specification information, and the user information are transferred to the network communication I/F 37 together with the address of a document storage server 20. The network communication I/F 37 transmits the current position information, the file specification information, and the user information that are transferred from the mobile terminal apparatus 30, to the document storage server 20 with the specified address. Note that the address of the document storage server 20 is stored in, for example, a predetermined region of the non-volatile memory 50D.

In step S104, it is determined whether the mobile terminal apparatus 30 has received the limited-access file corresponding to the file specification information via the network communication I/F 37 from the document storage server 20. If NO in step S104, a reception operation is continued until the mobile terminal apparatus 30 has received the limited-access file. If YES in step S104, the received limited-access file is stored on the hard disk 35, and the procedure proceeds to step S106.

Note that, in the first exemplary embodiment, the reception operation is continued until the mobile terminal apparatus 30 has received the limited-access file; however, in the case where YES is not obtained in step S104 within a predetermined time, a timeout may occur and the processing illustrated in FIG. 6 may end.

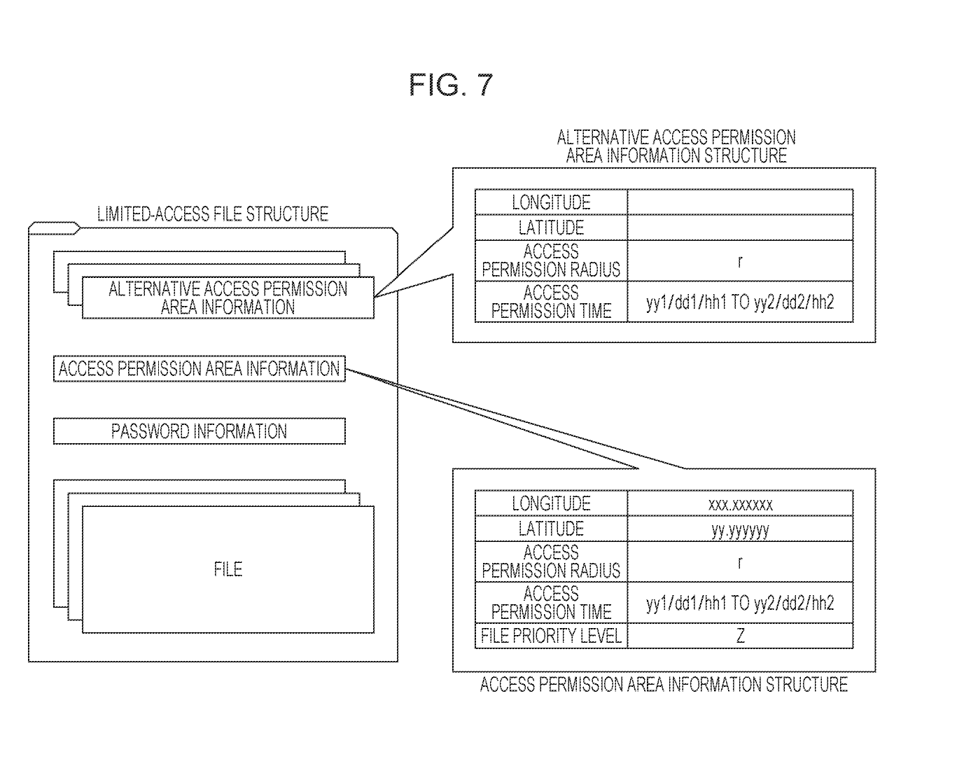

Next, the structure of the limited-access file acquired from the document storage server 20 will be described in detail with reference to FIG. 7.

The limited-access file according to the first exemplary embodiment includes, for example, alternative access permission area information, access permission area information, password information, and a file. Here, the limited-access file includes only one piece of access permission area information and one piece of password information; however, may include plural pieces of alternative access permission area information and files.

The access permission area information includes the longitude, the latitude, an access permission radius, an access permission time, and a file priority level, and the like.

The longitude and the latitude are set to be the current position information about the mobile terminal apparatus 30 transmitted to the document storage server 20 in step S102, that is, the current position information about the mobile terminal apparatus 30 detected in step S100. The access permission radius is set to be the radius of the access permission area. The access permission area has a circular shape with its center at the position indicated by the longitude and the latitude, that is, the position indicated by the current position information about the mobile terminal apparatus 30 detected in step S100 in the case where the download request file is selected. The access permission time is set to be a date and time range during which the file included in the limited-access file is permitted to be accessed. The file priority level is set to be a value representing the priority level according to the level of confidentiality of the file included in the limited-access file. For example, there are five levels for the file priority level, from the file priority level 1 to 5. The higher the file priority level is, the higher the level of confidentiality.

The file included in the limited-access file is a file specified by the file specification information transmitted to the document storage server 20 in step S102.

Next, the alternative access permission area information will be described in detail.

The alternative access permission area information includes the longitude, the latitude, an access permission radius, an access permission time, and the like.

At the time when the limited-access file is acquired for the first time, no values have been set for the latitude and the longitude of the alternative access permission area information. The access permission radius included in the alternative access permission area information is set to a value of the access permission radius included in the access permission area information. The access permission time included in the alternative access permission area information is set to a value of the access permission time included in the access permission area information.

The password information is set to be, for example, the password included in the user information transmitted to the document storage server 20 in step S102.

As described above, the limited-access file acquired in step S104 includes not only the download request file specified by the file specification information but also various pieces of information used to limit accessing of the download request file. Examples of the various pieces of information are the access permission area information and the like.

Note that the file name of the file (a download file) included in the limited-access file stored on the hard disk 35 of the mobile terminal apparatus 30 is displayed on the display of the operation display unit 33, for example, by using the file viewer and the like.

In step S106, it is determined whether the user of the mobile terminal apparatus 30 has selected a download file on the file viewer in order to access the download file. In the case where the user has not yet selected a download file, monitoring a download file selection status is continued until the user selects a download file. If a download file is selected by the user, the procedure proceeds to step S108.

In step S108, it is determined whether the time at which the user has selected the download file is included in the access permission time included in the access permission area information included in the limited-access file that includes the download file selected in step S106. If NO in step S108, the processing illustrated in FIG. 6 ends. If YES in step S108, the procedure proceeds to step S110.

In step S110, the detection unit 32 detects the current position information (access position information) about the mobile terminal apparatus 30.

In step S112, it is determined whether or not the position specified by the access position information detected in step S110 is within the access permission area defined by the longitude, the latitude, and the access permission radius included in the access permission area information included in the limited-access file that includes the download file.

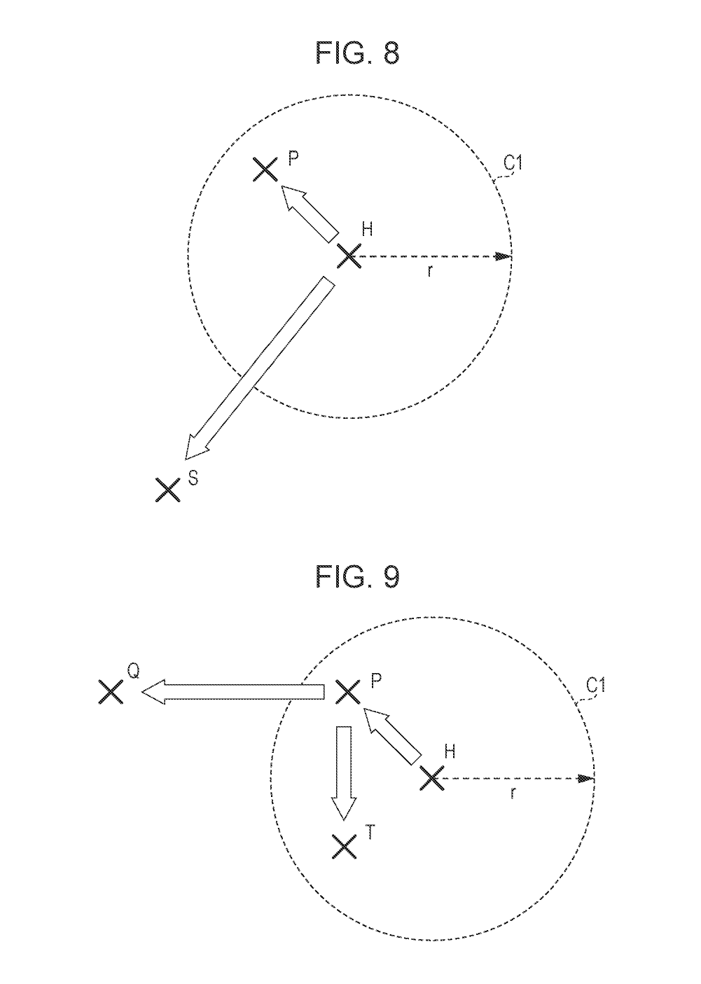

More specifically, as illustrated in FIG. 8, when the position specified by the longitude and the latitude included in the access permission area information is a position H and the access permission radius is denoted by r, the area inside a circle whose center is at the position H and that has the radius r is determined to be an access permission area C1 of the download file.

Note that, as described above, the position H indicates the position specified by the current position information about the mobile terminal apparatus 30 detected in step S100. That is, in step S112, it is determined whether the position at which the mobile terminal apparatus 30 accesses the download file is within the access permission area. When the mobile terminal apparatus 30 accesses the download file at a position P in FIG. 8, the mobile terminal apparatus 30 is determined to be within the access permission area. When the mobile terminal apparatus 30 accesses the download file at a position S in FIG. 8, the mobile terminal apparatus 30 is determined to be outside the access permission area.

If NO in step S112, the processing illustrated in FIG. 6 ends. If YES in step S112, the procedure proceeds to step S114.

In step S114, the download file selected in step S106 is accessed, the data structure of the download file is understood, and an application program is executed that converts the data of the download file into text, images, sound, videos, or the like by using the operation display unit 33.

The download file has a data region in which information that indicates a file format of the download file is stored. When the download file is accessed, this data region is first read. Then, an application program that understands the data structure of the download file in the read file format is selected and executed. Note that a file format table that shows relationships between file formats and application programs is stored in advance, for example, in a predetermined region of the non-volatile memory 50D.

Note that, when an application program is started, an identifier (a handle) that uniquely indicates the application program is generated and is stored in a predetermined region of the RAM 50C. Thereafter, the application program is controlled by using the handle, for example, when the application program is forced to terminate and the like.

In step S116, the detection unit 32 detects the current position information about the mobile terminal apparatus 30 in which execution of the application program is started in step S114.

In step S118, it is determined whether or not the position specified by the current position information about the mobile terminal apparatus 30 detected in step S116 is within the access permission area defined in step S112. If YES in step S118, the procedure proceeds to step S116 and detects the current position information about the mobile terminal apparatus 30 again. If NO in step S118, the procedure proceeds to step S120.

In step S120, the handle that is generated in step S114 and that corresponds to the application program that is currently being executed is read from the predetermined region of the RAM 50C. Then, the application program is forced to terminate by erasing the handle.

In the following, a case where an application program is forced to terminate will be described with reference to FIG. 9.

In FIG. 9, the position P is a position at which a download file is accessed and an application program corresponding to the download file is executed.

In the case where the user moves from the position P to a position T with the mobile terminal apparatus 30 while the application program is being executed, the mobile terminal apparatus 30 is within the access permission area C1. Thus, the application program continues to be executed. However, in the case where the user moves from the position P to a point Q with the mobile terminal apparatus 30, the mobile terminal apparatus 30 ends up being outside the access permission area C1. Thus, the application program is forced to terminate.

Note that, in step S116, in the case where the current position information about the mobile terminal apparatus 30 is not detected at a predetermined timing, whether or not the user of the mobile terminal apparatus 30 is within the access permission area is unknown. Examples of such a case are a case in which incoming signal strength decreases when the user goes underground and the like, a case in which the detection unit 32 does not work, and the like.

In such a case, when the current position information about the mobile terminal apparatus 30 is not detected over a predetermined time, the application program that is being executed may be forced to terminate by erasing the handle corresponding to the application program.

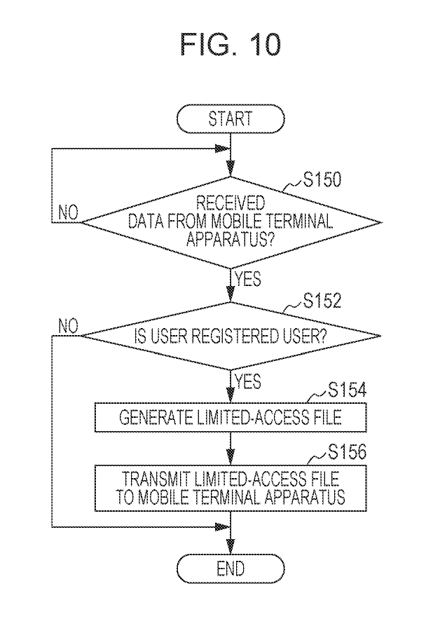

Next, operation of the document storage server 20 will be described with reference to FIG. 10 in the case where limited-access file generation processing according to the first exemplary embodiment is executed.

Note that the processing illustrated in FIG. 10 is a flowchart illustrating the processing procedure of a document storage program executed by the CPU 60A of the computer 60 in this case. The document storage program is stored in advance on a predetermined region of the hard disk 23.

When the document storage server 20 is started, the CPU 60A reads the document storage program stored on the hard disk 23 and executes the limited-access file generation processing according to the first exemplary embodiment.

In step S150, it is determined whether or not the document storage server 20 has received the current position information, file specification information, and user information about the mobile terminal apparatus 30 that are transmitted from the mobile terminal apparatus 30 via the network communication I/F 25 in step S102. If NO in step S150, receiving processing is continued. If YES in step S150, the received current position information, file specification information, and user information are stored in a predetermined region of the RAM 60C, and the procedure proceeds to step S152. Note that, in this case, the address of the mobile terminal apparatus 30 sent from the network communication I/F 25 is also stored in a predetermined region of the RAM 60C.

In step S152, it is determined whether or not the user of the mobile terminal apparatus 30 specified by the user information received in step S150 is a registered user with the right to access a file stored on the hard disk 23.

More specifically, the user of the mobile terminal apparatus 30 is determined to be a registered user in the case where, for example, a registered user table, which contains user IDs and passwords of registered users and which is stored in advance in a predetermined region of the non-volatile memory 60D, contains the user ID and the password included in the received user information.

If the user of the mobile terminal apparatus 30 is determined to be a non-registered user, the processing illustrated in FIG. 10 ends. That is, the file specified by the file specification information is not transmitted to the mobile terminal apparatus 30 from which the file specification information is transmitted. On the other hand, if the user of the mobile terminal apparatus 30 is determined to be a registered user, the procedure proceeds to step S154.

In step S154, a limited-access file is generated by using the current position information, file specification information, and user information received in step S150. Note that, the structure of a limited-access file has already been described above.

First, the file specified by the directory and the file name included in the received file specification information is acquired from the hard disk 23 of the document storage server 20 and is included in a limited-access file.

The password included in the received user information is stored as the password information in the limited-access file. Note that the password information is not limited thereto. For example, a password different from the password included in the received user information may be stored as the password information.

The longitude and the latitude included in the received current position information about the mobile terminal apparatus 30 are stored as the longitude and the latitude included in the access permission area information included in the limited-access file.

For example, a value stored in advance in a predetermined region of the non-volatile memory 60D is read and stored as a value of the access permission radius r included in the access permission area information and alternative access permission area information included in the limited-access file. Note that the value of the access permission radius need not be a fixed value. For example, the larger the value of the file priority level becomes (the higher the level of confidentiality of the file), the smaller the value of the access permission radius r may be.

An access permission time table, in which files are related to the access permission times corresponding to the levels of confidentiality of the files, is stored in advance, for example, on a predetermined region of the hard disk 23 when the files are stored on the hard disk 23 of the document storage server 20. Thus, the access permission time of the file specified by the file specification information is obtained by referring to the access permission time table. The obtained access permission time is stored as the access permission time included in the access permission area information and alternative access permission area information included in the limited-access file.

Note that, in the case where plural files are specified by the file specification information, it is desirable that, for example, a date and time range that includes all the access permission times for the plural files, a date and time range that overlaps all the access permission times for the plural files, or the like be stored as the access permission time included in the access permission area information and alternative access permission area information included in the limited-access file.

Similarly, a file priority level table, in which files are related to values of the file priority levels determined by the levels of confidentiality of the files, is stored in advance, for example, on a predetermined region of the hard disk 23 when the files are stored on the hard disk 23 of the document storage server 20. Thus, the file priority level of the file specified by the file specification information is obtained by referring to the file priority level table. The obtained file priority level is stored as the file priority level in the access permission area information included in the limited-access file. Note that, in the case where plural files are specified by the file specification information, it is desirable that the highest file priority level from among the file priority levels of the plural files be stored as the file priority level in the access permission area information included in the limited-access file.

In the first exemplary embodiment, the circle whose center is at the position indicated by the current position information about the mobile terminal apparatus 30 is defined as the access permission area; however, the shape of the access permission area is not limited thereto. The shape of the access permission area may be a rectangle, an ellipse, or others as long as the access permission area includes the position indicated by the current position information received in step S150. In this case, position information on apexes of a closed area that indicates an access permission area is included, instead of the access permission radius r, in the access permission area information and alternative access permission area information included in the limited-access file. The closed area obtained by connecting the positions of adjacent apexes specified by the position information is determined to be the access permission area.

In step S156, the limited-access file generated in step S154 is transferred to the network communication I/F 25 together with the address of the mobile terminal apparatus 30 from which the current position information and the like received in step S150 are transmitted. The network communication I/F 25 transmits the received limited-access file to the mobile terminal apparatus 30 specified by the address.

According to the first exemplary embodiment as described above, the position information about the mobile terminal apparatus 30 need not be stored in advance in the document storage server 20, and the access permission area for the download file is defined in accordance with the current position information received from the mobile terminal apparatus 30.

Moreover, when the mobile terminal apparatus 30 moves from inside to outside the access permission area defined for the download file while the application program corresponding to the download file is being executed, the application program is forced to terminate.

Furthermore, even when there are plural files in the limited-access file, single access permission area information is used for the files.

### Second Exemplary Embodiment

Next, a second exemplary embodiment of the invention will be described.

In the second exemplary embodiment, a case will be described in which an application program corresponding to a download file is executed even outside the access permission area defined for the download file, in addition to the processing described in the first exemplary embodiment.

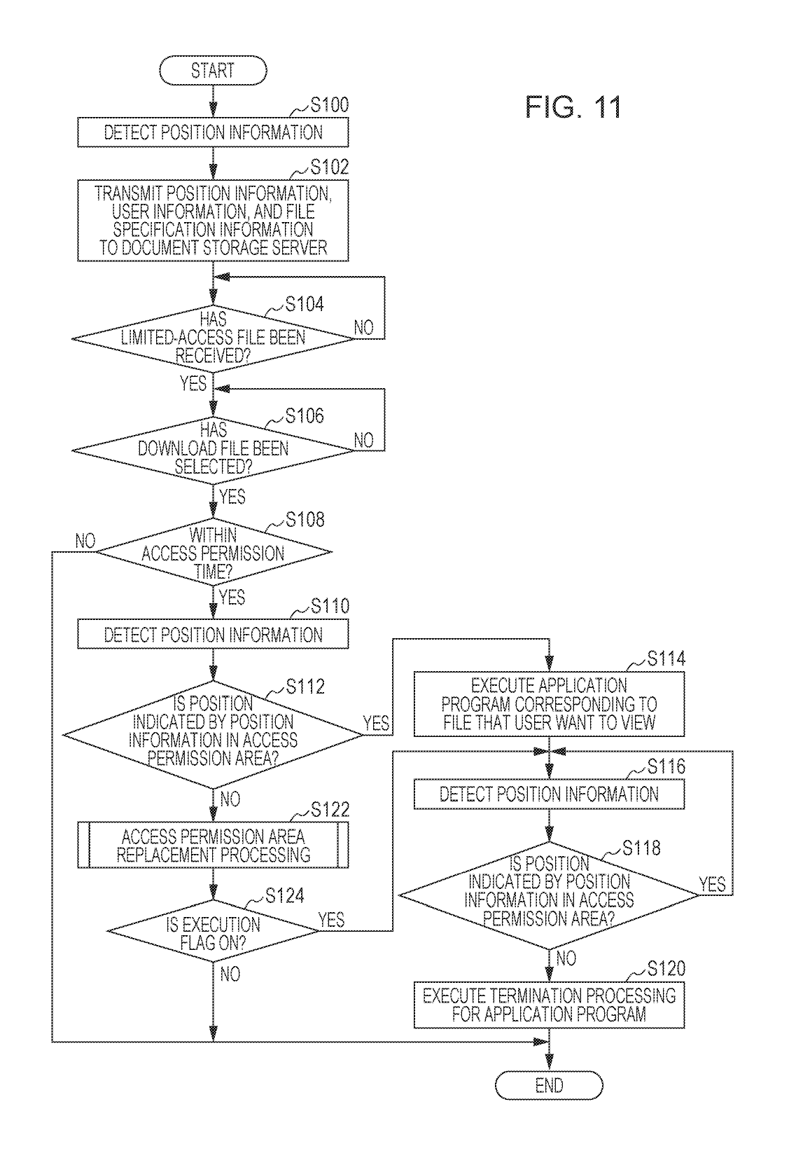

First, operation of the mobile terminal apparatus 30 will be described with reference to FIG. 11 in the case where the mobile terminal apparatus 30 executes access permission area replacement processing according to the second exemplary embodiment.

Note that the processing illustrated in FIG. 11 is a flowchart illustrating the processing procedure of a program that is for mobile terminal apparatuses and that is executed by the CPU 50A of the computer 50 in this case. The program is stored in advance on a predetermined region of the hard disk 35.

The access permission area replacement processing according to the second exemplary embodiment is executed by the CPU 50A, for example, in the case where the user of the mobile terminal apparatus 30 acquires information on the list of files stored on the hard disk 23 of the document storage server 20, starts a file viewer that displays the list of files onto a display of the operation display unit 33, and selects a download request file from among the list of files. The CPU 50A reads the program stored on the hard disk 35 to start execution of the access permission area replacement processing.

The processing illustrated in FIG. 11 differs from the processing illustrated in FIG. 6 in that steps S122 and S124 are added. The other steps are the same as those in the processing illustrated in FIG. 6, and thus the description thereof will be omitted.

In step S112, if the position specified by the access position information detected in step S110 is determined to be outside the access permission area defined for the download file, the procedure proceeds to step S122.

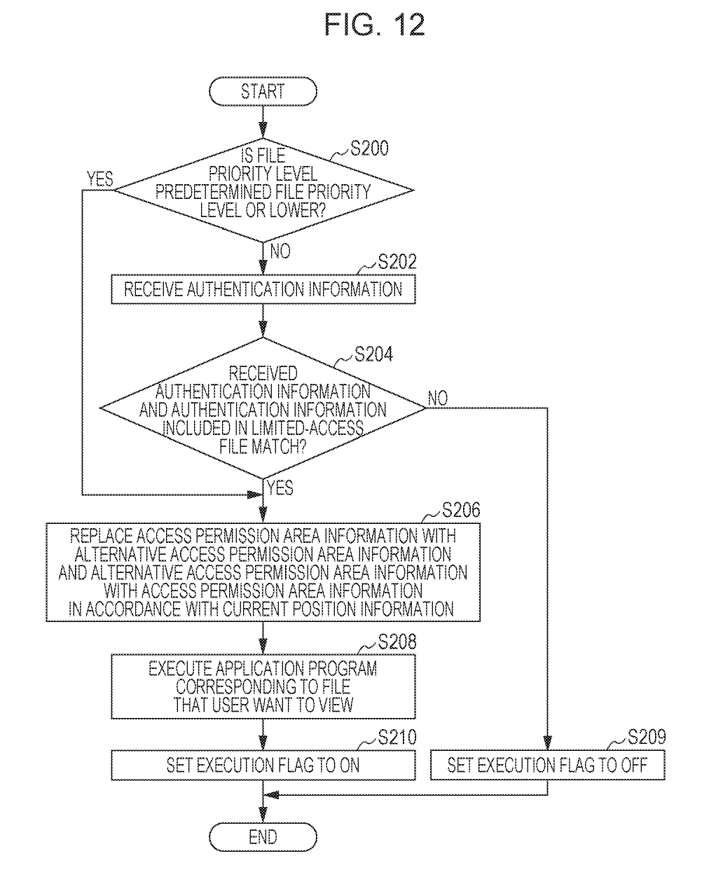

FIG. 12 is a diagram illustrating details of the access permission area replacement processing executed in step S122.

In step S200, it is determined whether the value of the file priority level of the limited-access file that includes the download file is smaller than or equal to a predetermined reference value for the file priority level by referring to the file priority level included in the access permission area information included in the limited-access file. If NO in step S200, the procedure proceeds to step S202. If YES in step S200, the procedure proceeds to step S206.

In this case, the predetermined reference value for the file priority level is stored, for example, in a predetermined region of the non-volatile memory 50D. For example, the predetermined reference value for the file priority level is set to a value that indicates that the user need not input authentication information if the file priority level of the download file is smaller than or equal to the value in the case where the download file is accessed in exceptional circumstances from outside the access permission area defined for the download file.

In step S202, the authentication information input from the operation display unit 33 by the user, that is, the password is received.

In step S204, the password received in step S202 is compared with the content of the password information included in the limited-access file that includes the download file selected in step S106, and it is determined whether they match or not. If NO in step S204, the procedure proceeds to step S209. If YES in step S204, the procedure proceeds to step S206.

In step S206, it is determined whether or not the position specified by the access position information detected in step S110 is within an alternative access permission area defined by the longitude, the latitude, and the access permission radius included in alternative access permission area information included in the limited-access file that includes the download file. Note that, if no values have been set for the longitude and the latitude of the alternative access permission area, it is not determined whether the position specified by the access position information detected in step S110 is within the alternative access permission area. Moreover, if there are plural pieces of alternative access permission area information, each of which includes the longitude and the latitude for which values are set, alternative access permission areas are defined by the plural pieces of alternative access permission area information. That is, each of the alternative access permission areas is defined by a corresponding one of the plural pieces of alternative access permission area information.

If the position specified by the access position information detected in step S110 is outside the alternative access permission area, the longitude and the latitude included in the access position information detected in step S110 are set for alternative access permission area information in which no values have been set for the longitude and the latitude, from among the pieces of the alternative access permission area information included in the limited-access file that includes the download file. Then, the access permission area is updated by replacing the access permission area information with the alternative access permission area information whose longitude and latitude are updated and the alternative access permission area information whose longitude and latitude are updated with the access permission area information.

That is, the access permission area information used previously is stored as the alternative access permission area information.

If the position specified by the access position information detected in step S110 is inside the alternative access permission area, that is, the alternative access permission area defined by the alternative access permission area information includes the position specified by the access position information detected in step S110, the access permission area is updated by replacing the alternative access permission area information with the access permission area information and the access permission area information with the alternative access permission area information.

That is, in the case where the download file is accessed again from inside the access permission area that has been previously defined, the previous access permission area information, which is stored, is reused.

In this case, replacement between the access permission area information and the alternative access permission area information is performed only in terms of common fields. That is, in FIG. 7, the file priority level remains unchanged in the access permission area information after replacement because the alternative access permission area information does not include the file priority level.

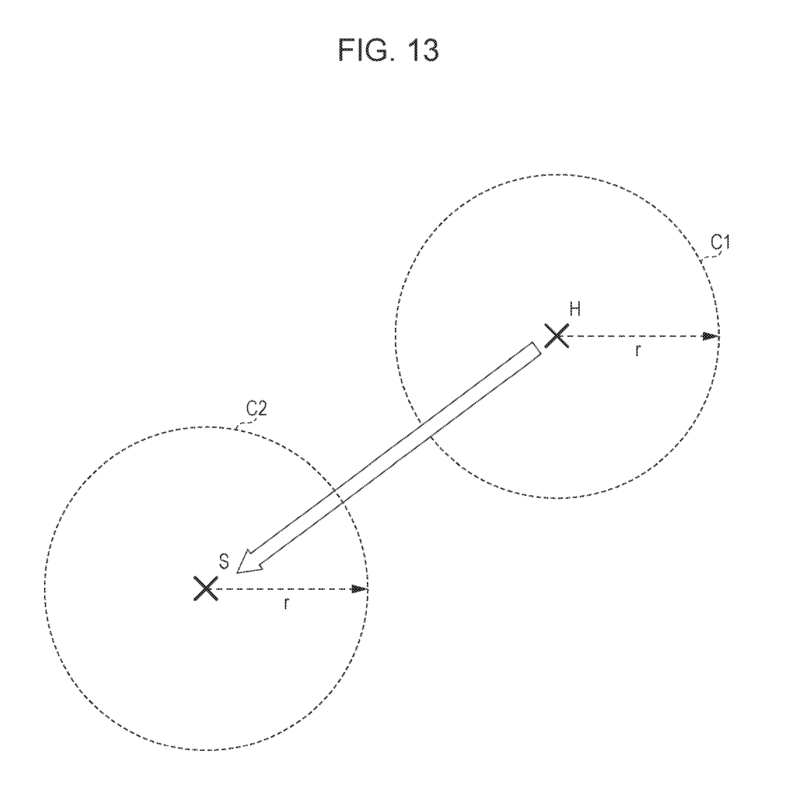

FIG. 13 is a diagram illustrating an example of how the access permission area is updated. It is assumed that the access permission area C1 whose center is at the position H is defined for the download file at first. As illustrated in FIG. 13, in the case where the user of the mobile terminal apparatus 30 moves from inside to the position S located outside the access permission area C1 and then accesses the download file, the longitude and the latitude included in the access permission area information are replaced with the position information on the position S and a new access permission area C2 is defined.

In step S208, similarly to as in step S114, the download file selected in step S106 is accessed, the data structure of the download file is understood, and the application program is executed that converts the data of the download file into text, images, sound, videos, or the like by using the operation display unit 33.

In step S210, a running flag ret is set to on in order to show that the application program corresponding to the download file is being executed. For example, the running flag ret is set to 1 and stored in a predetermined region of the RAM 50C.

In contrast, in step S209, the running flag ret is set to off because the application program corresponding to the download file is not being executed. For example, the running flag ret is set to 0.

In step S124 after step S122 illustrated in FIG. 11 is performed, the value of the running flag ret is read from the predetermined region of the RAM 50C, and it is determined whether or the running flag ret is set to on. That is, it is determined whether or not the application program corresponding to the download file is being executed.

If the running flag ret is determined to be set to on, the procedure proceeds to step S116, which has already been described. Then, it is monitored whether the user of the mobile terminal apparatus 30 is in the access permission area defined for the download file. If the running flag ret is determined to be set to off, the processing illustrated in FIG. 11 ends.

According to the second exemplary embodiment as described above, even from outside the access permission area defined for the download file, if authentication information included in the limited-access file generated by the document storage server 20 matches the authentication information input by the user of the mobile terminal apparatus 30, the application program corresponding to the download file is executed.

In this case, the access permission area defined for the download file is replaced with a new access permission area that includes the position specified by the current access position information, and the access permission area used before replacement is stored as the alternative access permission area.

Moreover, if the value of the file priority level defined for the download file is smaller than or equal to the predetermined reference value for the file priority level, the application program corresponding to the download file is executed even when the user of the mobile terminal apparatus 30 does not input the authentication information.

Note that, in the second exemplary embodiment, the access permission area defined by the access permission area information defined for the download file is updated by replacing the access permission area information with the alternative access permission area information. However, the way the access permission area is updated is not limited thereto. For example, the longitude and the latitude included in the access permission area information may be replaced, namely overwritten, with the longitude and the latitude included in the access position information.

In this case, the previous access permission area information is not stored as the alternative access permission area information.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A mobile terminal apparatus comprising:
a detection unit that detects current position information on a current position at a predetermined timing;
a transmission unit that transmits the current position information, user information that specifies a user of the mobile terminal apparatus, and file specification information that specifies a file that is to be acquired;
an acquisition unit that acquires a limited-access file from a document storage server that generates the limited-access file, which includes the file and access permission area information that defines an access permission area from which the mobile terminal apparatus is allowed to access the file in accordance with the current position information, in a case where the user specified by the user information is a registered user with a right to download the file specified by the file specification information; and
a permission unit that gives permission to access the file in a case where accessing of the file is commanded and a position specified by the current position information detected by the detection unit is included in the access permission area.

2. The mobile terminal apparatus according to claim 1, further comprising an execution unit that executes an application program corresponding to the file, accessing of which is permitted by the permission unit,
wherein, in a case where the user moves from inside to outside the access permission area, the permission unit instructs the execution unit to revoke permission to access the file and the execution unit terminates execution of the application program in a case where the application program is being executed.

3. The mobile terminal apparatus according to claim 2,
wherein, in a case where the current position information is not detected by the detection unit at the predetermined timing and the application program corresponding to the file, accessing of which is permitted by the permission unit, is being executed, the execution unit terminates the application program in a case where the current position information is not detected over a predetermined time.

4. The mobile terminal apparatus according to claim 1, further comprising a reception unit that receives authentication information input by the user,
wherein the acquisition unit acquires the limited-access file, which includes authentication information, from the document storage server, and
wherein the permission unit gives permission to access the file in a case where the position specified by the current position information detected by the detection unit is outside the access permission area and the authentication information input by the user matches the authentication information included in the limited-access file.

5. The mobile terminal apparatus according to claim 2, further comprising a reception unit that receives authentication information input by the user,
wherein the acquisition unit acquires the limited-access file, which includes authentication information, from the document storage server, and
wherein the permission unit gives permission to access the file in a case where the position specified by the current position information detected by the detection unit is outside the access permission area and the authentication information input by the user matches the authentication information included in the limited-access file.

6. The mobile terminal apparatus according to claim 3, further comprising a reception unit that receives authentication information input by the user,
wherein the acquisition unit acquires the limited-access file, which includes authentication information, from the document storage server, and
wherein the permission unit gives permission to access the file in a case where the position specified by the current position information detected by the detection unit is outside the access permission area and the authentication information input by the user matches the authentication information included in the limited-access file.

7. The mobile terminal apparatus according to claim 1,
wherein the acquisition unit acquires the limited-access file, which includes a file priority level representing a priority level according to the level of confidentiality of the file, from the document storage server, and
wherein the permission unit gives permission to access the file in a case where the position specified by the current position information detected by the detection unit is outside the access permission area and the file priority level is smaller than or equal to a predetermined priority level.

8. The mobile terminal apparatus according to claim 2,
wherein the acquisition unit acquires the limited-access file, which includes a file priority level representing a priority level according to the level of confidentiality of the file, from the document storage server, and
wherein the permission unit gives permission to access the file in a case where the position specified by the current position information detected by the detection unit is outside the access permission area and the file priority level is smaller than or equal to a predetermined priority level.

9. The mobile terminal apparatus according to claim 4,
wherein, in a case where the position specified by the current position information detected by the detection unit is outside the access permission area, the permission unit updates the access permission area information included in the limited-access file acquired by the acquisition unit in such a manner that an access permission area defined by the updated access permission area information includes the position specified by the current position information detected by the detection unit, and gives permission to access the file.

10. The mobile terminal apparatus according to claim 7,
wherein, in a case where the position specified by the current position information detected by the detection unit is outside the access permission area, the permission unit updates the access permission area information included in the limited-access file acquired by the acquisition unit in such a manner that an access permission area defined by the updated access permission area information includes the position specified by the current position information detected by the detection unit, and gives permission to access the file.

11. The mobile terminal apparatus according to claim 4,
wherein, in a case where the position specified by the current position information detected by the detection unit is outside the access permission area, the permission unit updates alternative access permission area information with the access permission area information, updates the access permission area information with information on a new access permission area that includes the position specified by the current position information detected by the detection unit, and gives permission to access the file.

12. The mobile terminal apparatus according to claim 7,
wherein, in a case where the position specified by the current position information detected by the detection unit is outside the access permission area, the permission unit updates alternative access permission area information with the access permission area information, updates the access permission area information with information on a new access permission area that includes the position specified by the current position information detected by the detection unit, and gives permission to access the file.

13. The mobile terminal apparatus according to claim 11,
wherein, in a case where the position specified by the current position information detected by the detection unit is outside the access permission area but in an alternative access permission area specified by the alternative access permission area information, the permission unit replaces the access permission area information with the alternative access permission area information and the alternative access permission area information with the access permission area information, and gives permission to access the file.

14. A non-transitory computer readable medium storing a program causing a computer to execute a process, the process comprising:
transmitting current position information, user information that specifies a user of a mobile terminal apparatus, and file specification information that specifies a file that is to be acquired;
acquiring a limited-access file from a document storage server that generates the limited-access file, which includes the file and access permission area information that defines an access permission area from which the mobile terminal apparatus is allowed to access the file in accordance with the current position information, in a case where the user specified by the user information is a registered user with a right to download the file specified by the file specification information; and
giving permission to access the file in a case where accessing of the file is commanded and a position specified by the current position information is included in the access permission area.

15. A signal processing method comprising:
detecting current position information on a current position at a predetermined timing;
transmitting the current position information, user information that specifies a user of the mobile terminal apparatus, and file specification information that specifies a file that is to be acquired;
acquiring a limited-access file from a document storage server that generates the limited-access file, which includes the file and access permission area information that defines an access permission area from which the mobile terminal apparatus is allowed to access the file in accordance with the current position information, in a case where the user specified by the user information is a registered user with a right to download the file specified by the file specification information; and
giving permission to access the file in a case where accessing of the file is commanded and a position specified by the current position information is included in the access permission area.

16. A document storage server comprising:
an acquisition unit that acquires position information about a mobile terminal apparatus, user information that specifies a user of the mobile terminal apparatus, and file specification information that specifies a file that is to be acquired;
a generation unit that generates a limited-access file which includes the file and access permission area information that defines an access permission area from which the mobile terminal apparatus is allowed to access the file in accordance with the position information, in a case where the user specified by the user information is a registered user with a right to download the file specified by the file specification information; and
a transmission unit that transmits the limited-access file generated by the generation unit to the mobile terminal apparatus.

17. The document storage server according to claim 16,
wherein, in a case where a plurality of files that are to be acquired are specified by the file specification information, the generation unit generates a limited-access file which includes the plurality of files and information on a single access permission area defined for the plurality of files in accordance with the position information.

18. A non-transitory computer readable medium storing a document storage program causing a computer to execute a process, the process comprising:
acquiring position information about a mobile terminal apparatus, user information that specifies a user of the mobile terminal apparatus, and file specification information that specifies a file that is to be acquired;
generating a limited-access file which includes the file and access permission area information that defines an access permission area from which the mobile terminal apparatus is allowed to access the file in accordance with the position information, in a case where the user specified by the user information is a registered user with a right to download the file specified by the file specification information; and
transmitting the limited-access file generated by the generation unit to the mobile terminal apparatus.

19. A document management system comprising:
the mobile terminal apparatus according to claim 1; and
the document storage server according to claim 16.
